(19) United States
(12) Patent Application Publication
(10) Pub. No.: US 2014/0126575 A1
(43) Pub. Date: May 8, 2014

(54) Method of Routing a Multicast Stream in Non-Storage Mode

(71) Applicants: Christophe Janneteau, Chaudon (FR); Mounir Kellil, Massy (FR)

(72) Inventors: Christophe Janneteau, Chaudon (FR); Mounir Kellil, Massy (FR)

(73) Assignee: Commissariat a L'energie Atomique et aux Energies Alternatives, Paris (FR)

(21) Appl. No.: 14/129,572

(22) PCT Filed: Jul. 9, 2012
(86) PCT No.: PCT/EP2012/063420

§ 371 Date: Dec. 27, 2013

(30) Foreign Application Priority Data
Jul. 11, 2011 (FR) 1156273

(51) Int. Cl. H04L 12/18

(52) U.S. Cl. CPC H04L 12/18
USPC 370/390

(57) ABSTRACT

The invention relates to a method for routing in non-storing mode, a stream exchanged between a source and at least one receiver including the following steps:
associating in a multicast routing table managed by a root node (4) the unicast address of the receiver and the multicast address of the group which the receiver has joined,
sending the stream from the source to the root node, and, on receipt of the stream, the root node (4) generates a copy of the said stream, inserts in the packets of the copy of the generated stream a routing header including the unicast address of the addressee receiver of the stream, and sends the said stream to the receiver.

### TECHNICAL FIELD

The invention is in the field of telecommunication networks, and relates more particularly to a method for routing, in non-storing mode, a stream of messages exchanged between a source and at least one receiver identified by a unicast address, and having previously joined at least one multicast group in a network of the LLN (Lower power and Lossy channel Network) type including a set of non-storing nodes and a root node, capable of recording routing data.

A non-storing mode in a network such as an LLN-type network is a network context in which the network nodes have very little memory, or no memory at all.

The invention applies particularly but not exclusively to accomplishing multicast operations via computer networks with strong constraints in terms of available resources (batteries, memories, computation capacities, available connections, etc.). Such networks are often known by the term LLN (Lower power and Lossy channel Network). An example of such an LLN network is the RPL (IPv6 Routing Protocol for Low power and Lossy Networks) network in a mode called a non-storing mode.

The invention combines simultaneously the context of low-resource computer/telecoms networks (LLNs), for example wireless sensor networks, and multicast IP communications.

### STATE OF THE PRIOR ART

One technical problem of the prior art results from the fact that support for multicast routing has not been covered satisfactorily in the context of networks with very small resources, i.e. LLN networks. In particular, if routing nodes in the LLN context have little memory, or no memory, this makes conventional Internet multicast routing solutions (e.g. MOSPF, PIM-SM, etc.) inoperable in the LLN context, since these require states, such as routing tables, etc. to be stored. This problem is particularly complicated since, in the case of an RPL network specifically, the technique of unicast routing for the non-storing mode, called source routing, does not allow multicast addresses to be used in the routable packets, with a view to preventing attacks by network flooding or denial of service (DoS).

Consequently, a new multicast routing technique for non-storing mode must be defined.

The document [“S. Peng et al. “SenCast: Scalable Multicast in Wireless Sensor Networks”, IEEE IPDPS Conference, 2008] describes a multicast solution for sensor networks in which a special node called a sink collects the data in the vicinity of each sensor. The global topology of the network is constituted at the sink's level. This topology contains the position of each sensor, the identifier of each sensor, and the vicinity relationship between sensors. The sink constructs the multicast tree using an algorithm called a Steiner tree approximation algorithm, which calculates the minimal/optimal multicast tree for a set of sensors. Although this solution mentions the use of a routing header for the transmission of multicast packets from the sink, once the tree has been constructed it does not describe any mechanism for constructing the routing header, or for the managing the associated routing table.

The document [M. Bag-Mohammadi et al. “On the efficiency of explicit multicast routing protocols”, IEEE ISCC Conference, 2005] describes a solution in which a multicast source generates the description code of the multicast tree, and includes it as a header in the data packets. The generated code contains the IP addresses of all the receivers, and those of a set of specific routers of the tree called BPs (Branching Points). The source collects the description of the multicast tree from join requests of the members of the multicast group. When a BP router receives a data packet it decodes the code of the tree in order to determine the next BP(s) and/or receiver(s). The current BP then generates the necessary copies of the packet and sends them to the IP addresses determined from the code.

This solution does not support transfer of packets of the multicast IP type in the routers. In addition, it does not describe any multicast routing table management operation. Finally, this solution is not suitable for networks involving nodes having no storage processing capacity, which are consequently unable to generate copies of the packets to be routed.

One aim of the invention is to overcome the disadvantages of the prior art described above.

### DESCRIPTION OF THE INVENTION

One aim of the invention is to route the packets for a multicast group without the routing information, whether multicast or unicast, being present in the routing nodes.

Another aim of the invention is to accomplish end-to-end multicast routing, in non-storing mode, in a transparent manner relative to any intermediate routing nodes between the source and the receiver which is the addressee of the stream. This is obtained by a method for routing in non-storing mode packets of a stream exchanged between a source and at least one receiver Hi (i=1, 2, 3, etc.) identified by a unicast address, and having previously joined at least one multicast group MCj (j=1, 2, 3, etc.) in a network of the LLN type including a set of non-storing nodes Ni (i=1, 2, 3, etc.) and a root node, capable of recording the routing data.

The method according to the invention includes the following steps:
sending through receiver Hi to the root node a request to join a multicast group MCj (j=1, 2, 3, etc.) containing the unicast address of receiver Hi and the multicast address of the said multicast group,
associating, in a multicast routing table managed by the root node, multicast address MCj with the unicast address of receiver Hi having joined multicast group MCj, and also with the list of intermediate nodes on the path between the root node and said receiver Hi;
transmitting a packet of a multicast stream from the source to the root node;

and on receipt of the packet of the multicast stream, the root node generates a copy of the said packet, adds to the generated copy a routing header containing a list of intermediate nodes on the path between the root node and said receiver Hi, and sends the said copy of the multicast packet to receiver Hi via the said list of intermediate nodes.

In a variant embodiment of the method according to the invention, the multicast routing table managed by the root node also includes a list of intermediate nodes intended to resend the packets from the root node to the receiver.

According to the invention, to join the multicast group, the receiver sends the root node a join request containing its unicast address and the multicast address of the group via a DAO (Destination Advertisement Object) message of RPL (Routing Protocol for Low power and Lossy Networks) protocol or via an MLD (Multicast Listener Discovery) report message. The receiver sends the said join request with a link-local multicast or sends it directly to the root node in unicast mode, and on receipt of the request the root node records the receiver in the multicast routing table.

### BRIEF DESCRIPTION OF THE ILLUSTRATIONS

Other characteristics and advantages of the invention will become clear from the following description, which is given as a non-restrictive example, with reference to the appended figures, in which:

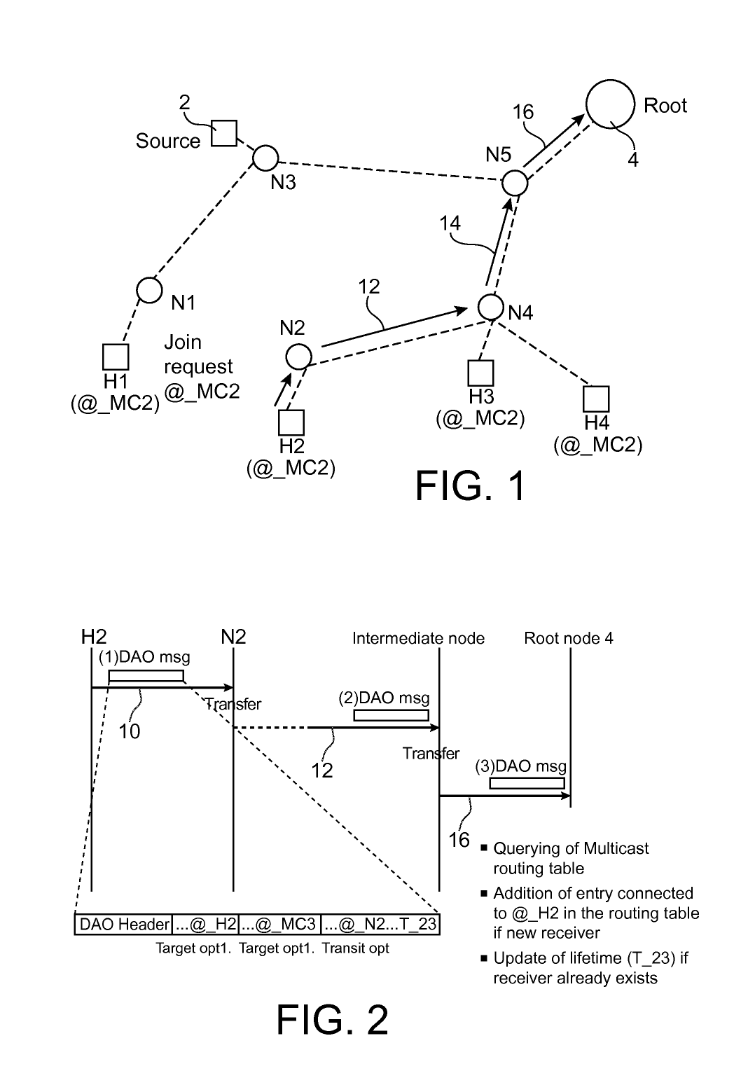

FIG. 1 represents schematically the architecture of an example of an LLN type network,

FIG. 2 illustrates schematically a procedure for a receiver to join a multicast group in a network according to the invention,

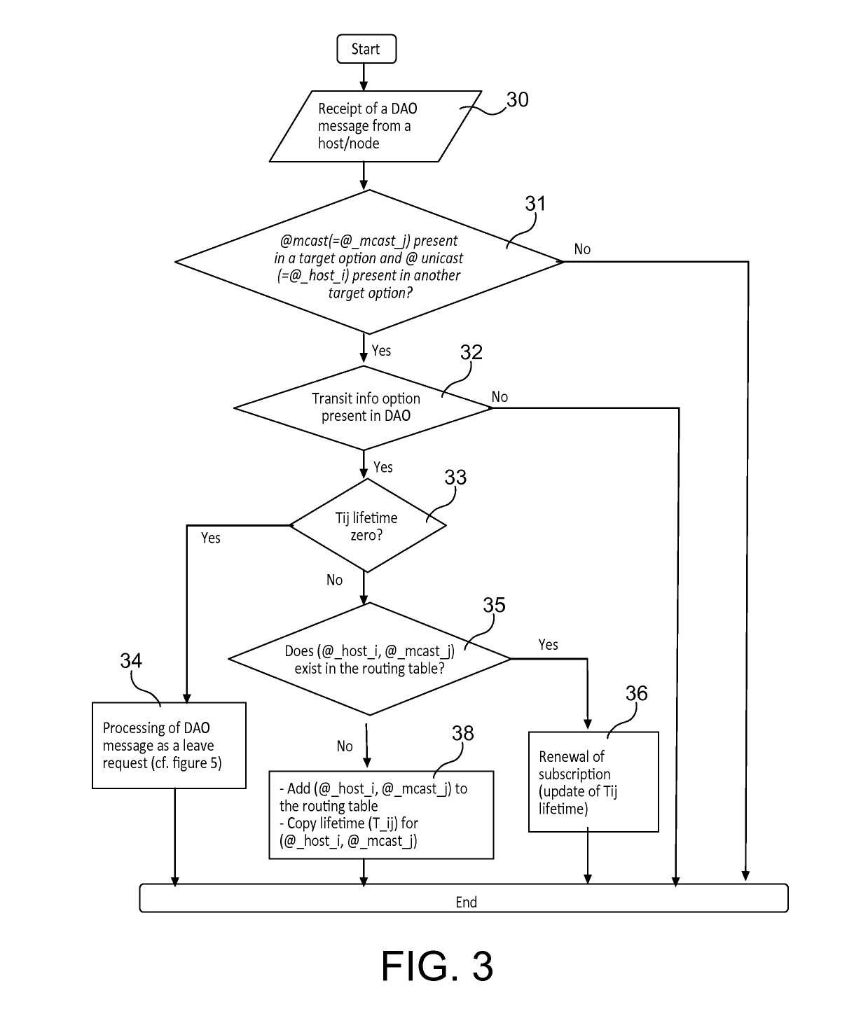

FIG. 3 is a flow chart illustrating how the root node processes the requests of a receiver to join a multicast group according to the invention;

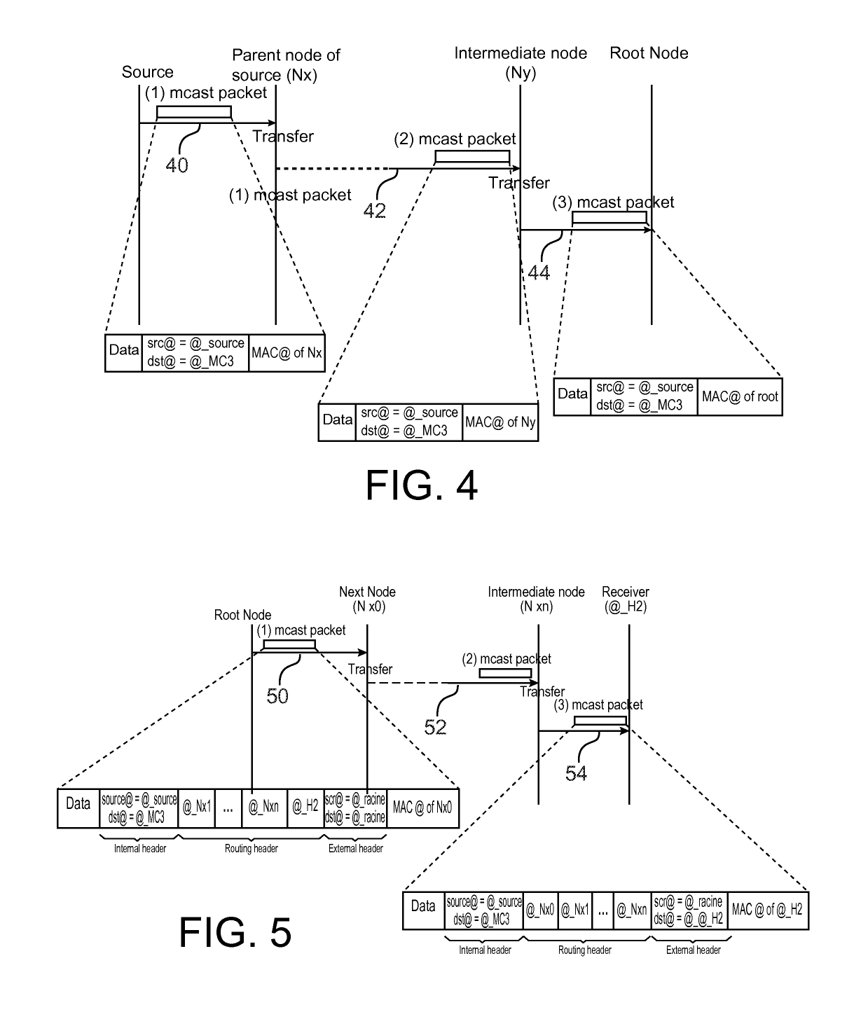

FIG. 4 illustrates schematically how packets of a stream are transferred from a source to a root node according to the invention,

FIG. 5 illustrates schematically how packets of the stream are transferred from the root node to a receiver of a multicast group according to the invention;

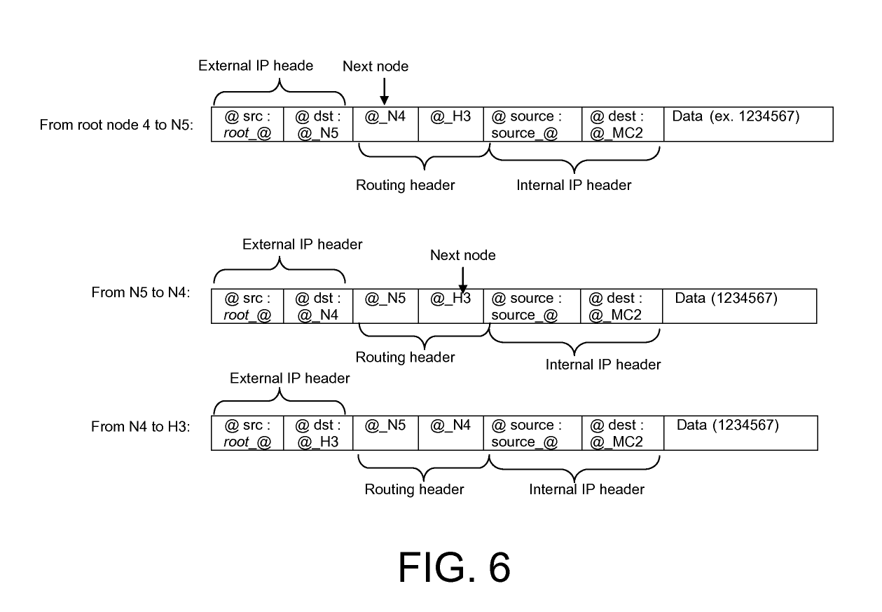

FIG. 6 illustrates schematically the successive addressing to send a multicast packet from the root node to a receiver belonging to a multicast group according to the invention;

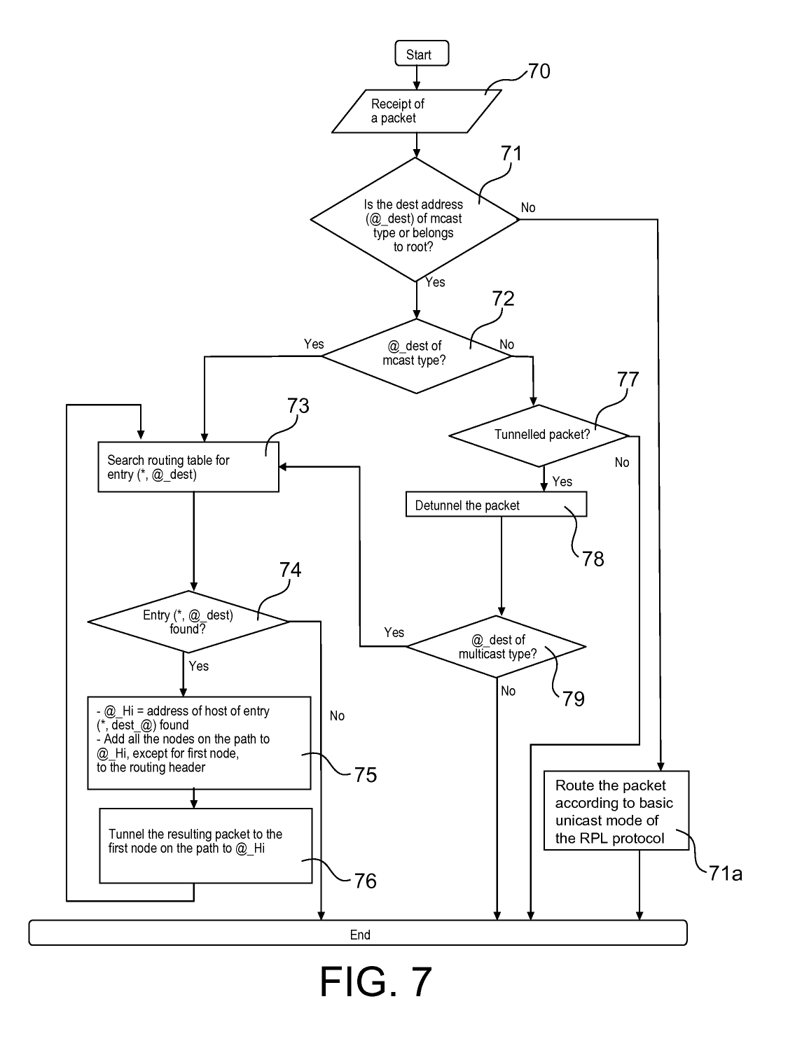

FIG. 7 is a flow chart illustrating how the root node processes a received data packet according to the invention;

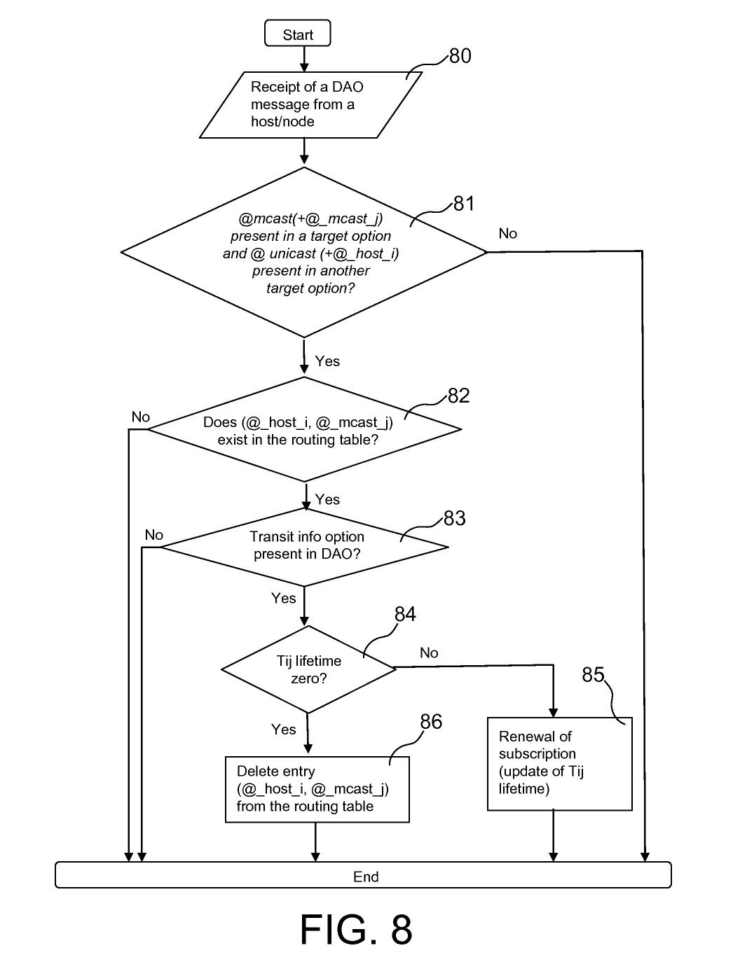

FIG. 8 is a flow chart illustrating how the root node processes a withdrawal request of a receiver of a multicast group,

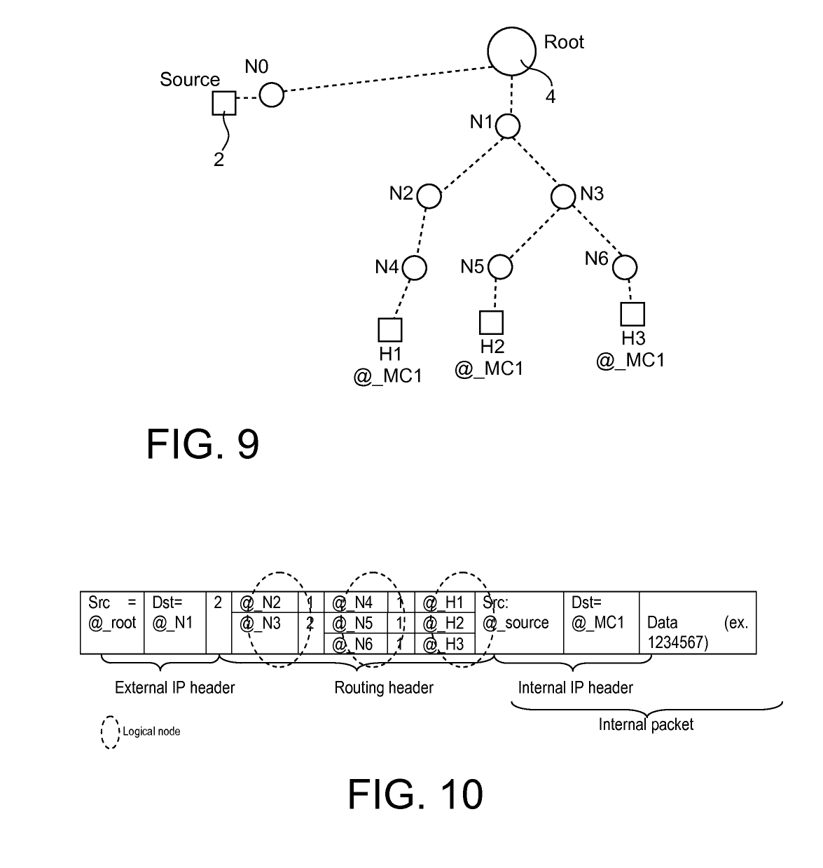

FIG. 9 illustrates schematically a variant of a routing tree defined by the root node according to the invention.

FIG. 10 illustrates schematically a generic format of a multicast packet on leaving the root node according to the invention,

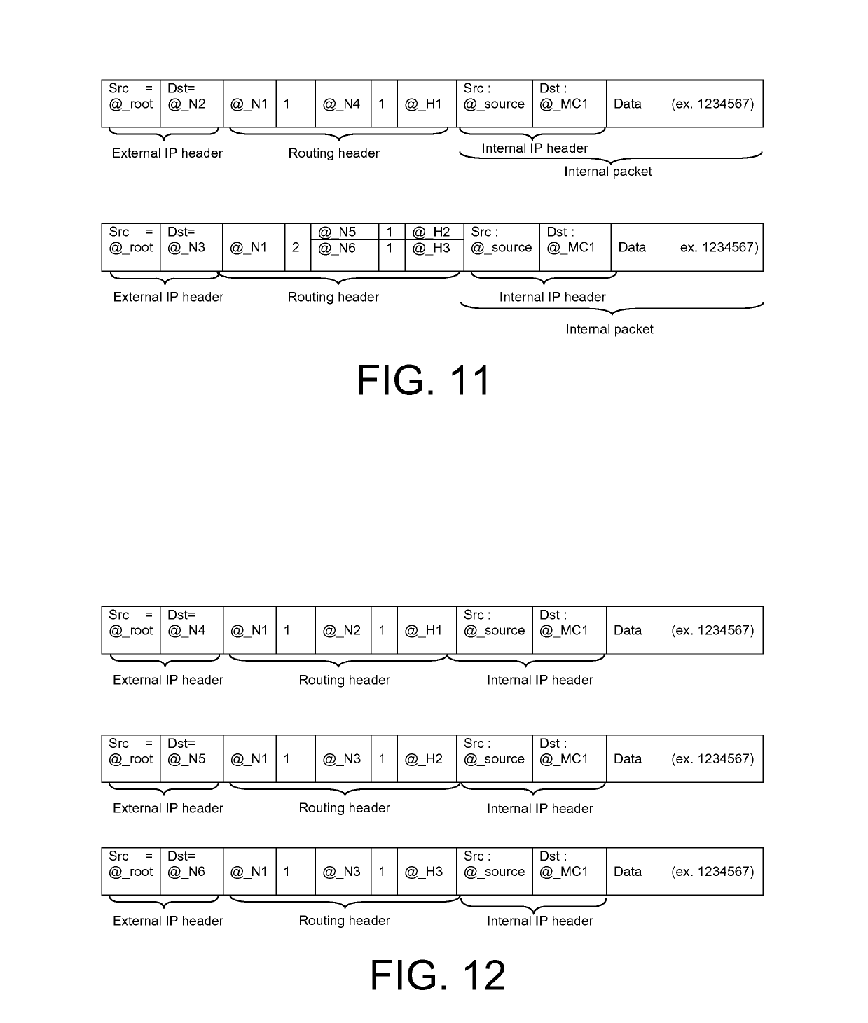

FIGS. 11 and 12 illustrate schematically the changes of the generic format of FIG. 10 when the packet is sent from the root node to a receiver according to the invention;

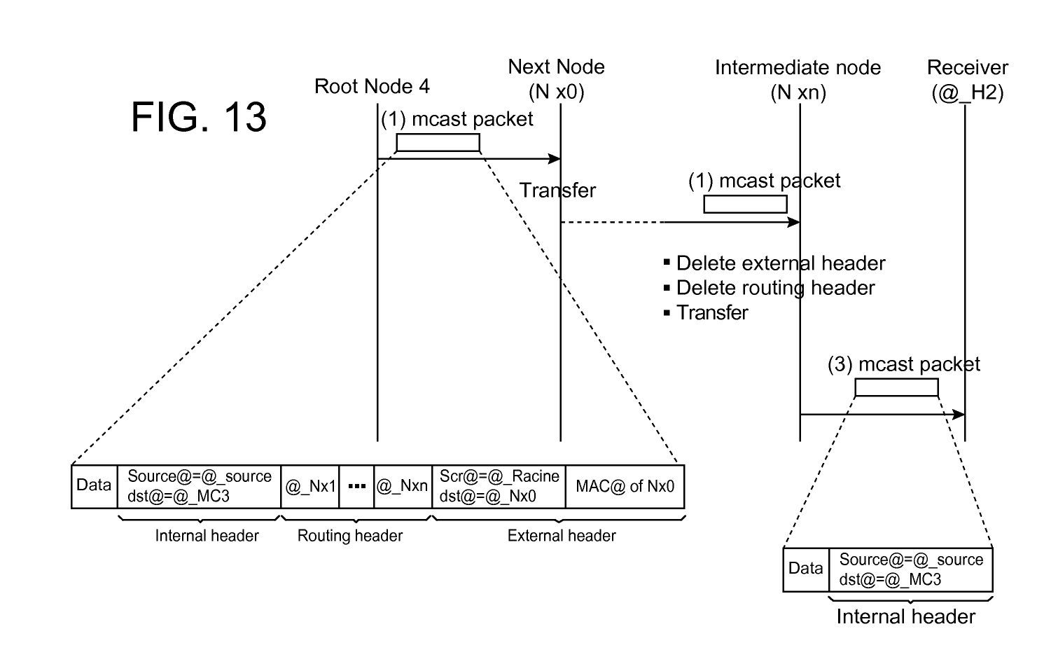

FIG. 13 illustrates schematically a second variant according to the invention of how the packets are transferred from the root node to a receiver of a multicast group.

### DETAILED DESCRIPTION OF PARTICULAR EMBODIMENTS

The invention will be described, with reference to FIG. 1, for the routing of the packets of a stream transmitted from a source 2 to several receivers H1, H2, H3 and H4, called hosts, in an LLN network.

As is illustrated by FIG. 1, the LLN network consists of a set of non-storing nodes N1, N2, N3, N4 and N5 and of a special node called the root node 4, which is able to store routing data. An example of this type of configuration is the non-storing mode of the RPL (Routing Protocol for Low power and Lossy Networks) protocol.

It should be recalled that in non-storing mode the stream of data is firstly sent step-by-step to root node 4 which then constructs the routing header required for the subsequent transmission of the packet step-by-step to the final destination. The other nodes N1, N2, N3, N4 and N5 of the network cannot undertake this type of operation since they have very little memory, or no memory at all.

The invention introduces the following aspects, which will be described in detail in the remainder of the description:
Definition of a specific signalling message for the RPL protocol, enabling a host to join a multicast group. The message combines the unicast address of the host with the multicast address of the group.
Definition of a specific signalling message for the RPL protocol, enabling a host to leave a multicast group. The message combines the unicast address of the host with the multicast address of the group.
Definition of a multicast routing table in root node 4; where the routing table combines a multicast address of a group with a list of unicast addresses of hosts.
Definition of a mechanism to construct, using the said multicast routing table, a routing header associated with a multicast group after receiving a multicast packet transmitted by the source. The routing header is constructed by root node 4.
Definition of a mechanism for deleting entries of the multicast routing table when a host leaves the multicast group, or when a host's membership of a multicast group expires.

Prior to the transmission of the multicast stream by source 2, each host Hx, (x=1, 2, 3, 4 etc.) joins a multicast group identified by a multicast address multicast @MCj able to receive this stream. To this end, host Hx sends a multicast join request via a DAO (Destination Advertisement Object) message of RPL or an MLD (Multicast Listener Discovery) report message, for example. The join request contains the unicast address of the host and also the multicast address of the group which the host wishes to join. The host sends its join request with a link-local multicast or in unicast mode directly to root node 4 for example, i.e. when the destination address mentioned in the join request is the address of root node 4. In the latter case, the join request may transit through intermediate router nodes if root 4 is several stages from the host (for example, if it is not in radio reach).

In all cases the join request will arrive at root node 4, which will then record the new host in a new specific routing table. This routing table contains, in particular, the unicast address of the host, the multicast address associated with it, and the list of the intermediate nodes which enable the packets from root node 4 to reach the host. An example of such a routing table is illustrated below for a number n of hosts and 3 multicast groups, where @_X signifies the IP address of node X, and T_xy signifies the lifetime of host Hx's membership of group MCy.

TABLE 1

| | Multicast address | | |
|---|---|---|---|
| Unicast address | of the host's | | |
| of the host | group | Lifetime | Intermediate nodes |
| @_H1 | @_MC1 | T_11 | @_N5, @_N3, @_N1 |
| @_H2 | @_MC3 | T_23 | @_N5, @_N4, @_N2 |
| @_H3 | @_MC2 | T_32 | @_N5, @_N4 |
| @_H4 | @_MC2 | T_42 | @_N5, @_N4 |
| @_Hn − 1 | @_MC1 | T_n − 11 | etc. |
| @_Hn | @_MC3 | T_n3 | etc. |

The exchange of a DAO message to cause host H2 to join a multicast group identified by a multicast address @MC3 is illustrated by the arrows in FIGS. 1 and 2.

In step 10 host H2 sends a DAO message which will reach the root via node N2. If host H2 supports signalling messages specific to LLN networks as in an RPL network, the DAO message of the RPL protocol may be used with two options of the “target” type and at least one “transit information” option for each “target” option (to be in compliance with the specification of the RPL protocol). Each “transit information” option gives the address of a parent node of the host. However, both “transit” options may give the address of an identical parent node of the host. In the example of FIG. 2 host H2 will send a DAO request with the following format:

AO header

| @_H2 | @_N2 | @_MC3 | @_N2.T_23 |
|---|---|---|---|
| Target opt1 | Transit opt1 | Target opt2 | Transit op2 |

The two target options contain in succession the address of the host (@_H2) and the multicast address of the group (@_MC3) which the host wishes to join. The lifetime of the membership is contained in one of the two “transit information” options; preferably in the “transit information” option associated with the “target” option giving the multicast membership address.

It should be noted that the order of the address of the host (@_H2) and of the multicast address of the group (@_MC3) in the DAO message is unimportant.

In step 12 node N2 sends the DAO message to intermediate node N4. This sends the DAO message to next intermediate node N5 (step 14), which sends it to root node 4 (step 16).

In another variant the join request may include just the “target” option containing the multicast address with the “transit information” option including the parent node and the lifetime of the membership. This is the case if the unicast address of the host is mentioned as the source address of the IP header of the DAO message arriving at root node 4. In this case, as in the case of the previous DAO message, the host sends the DAO message directly to root node 4 via the intermediate router nodes.

When root node 4 receives the DAO message it checks in particular the target options. The existence of a multicast address in a target option informs root node 4 that this is a request to join a multicast group. If the association (host address, multicast address) does not exist in the routing table root node 4 adds an entry to it corresponding to the new host. If the entry already exists the lifetime for the association (host address, multicast address) will be reset to a maximum value, i.e. the membership of the host in the associated group will be renewed. It should be noted that the lifetime of a first membership is copied by root node 4 in the corresponding entry of the routing table. However, root node 4 is free to set a lifetime of a membership by means of an internal decision, for example if this lifetime is not stipulated in the subscription message. For example, following step of FIG. 2, root 4 receives from node N5 the DAO message sent by host H2. In this step the root constitutes the multicast routing table, adds to it address @H2 if the latter is not yet present in it, and updates the membership period of host H2 in multicast group @MC3.

In another embodiment host H2 is made a member of a multicast group identified by a multicast address @MC3 through the transmission of an MLD request.

It should be noted that if host H2 wishes to join a multicast group by sending an MLD report, the join request message will then be intercepted by a router RPL node which transfers it to root node 4. Indeed, in storing mode of the RPL protocol, as soon as a router receives an MLD report message it transforms it into a DAO message which will be transmitted step-by-step to root node 4.

The invention therefore enables the MLD report message to be transformed into a DAO message in non-storing mode. When the DAO message has been created it will then be sent directly to root node 4.

The format of the DAO message is the one described above.

FIG. 3 is a flow chart illustrating how root node 4 processes the requests of a host receiver to join a multicast group according to the invention.

In step 30 root node 4 receives the DAO message from the host node.

In step 31 root node 4 checks whether or not a mcast @ address (e.g. @_mcast_j) is present in a target option, and whether or not a unicast @address (e.g. @_host_i) is present in another target option.

If both these addresses are present in target options root node 4 proceeds to step 32.

If no multicast address is present in a target option processing of the message is terminated.

If a multicast address is present in a target option but no unicast address is present in a target option, root node 4 then uses the source address of the DAO message as the said unicast address (e.g. =0_host_i) and proceeds to step 32.

In step 32 root node 4 checks whether or not the transit info option is present in the message in DAO.

If the transit info option is not present in the DAO message, processing of the message is terminated.

Otherwise root node 4 checks, in step 33, whether lifetime Tij of membership of a host in the multicast group is zero.

If so, root node 4 processes, in step 34, the DAO message as a request to leave the multicast group.

Otherwise root node 4 checks, in step 35, whether the association (@_host_i, @_mcast_j) exists in the routing table.

If so, root node 4 renews, in step 36, the host's membership of the multicast group.

Otherwise root node 4 adds, in step 38, the association of addresses (@_host_i, @_mcast_j) to the routing table and copies the lifetime (T_ij) for (@_host_i, @_mcast_j).

After the host receivers have joined the multicast group, the data packets are transferred from source 2 to these hosts in two phases: a first phase during which the packets are first sent from source 2 to root node 4, and a second phase during which the packets are sent from root node 4 to the host receivers.

FIG. 4 illustrates schematically how the multicast packets are transferred from source 2 to root node 4.

During the first phase, source 2 sends (step 40) the packets to one or more routing nodes in its vicinity which are within its reach. This transmission may be made either in multicast mode (basic/preferred mode) or in tunnelled multicast mode (multicast in unicast).

If the node in the vicinity of source 2 receives a multicast packet it sends it (step 42) in an unchanged state from its output interface to the next intermediate node, which sends it to root node 4 (step 44).

According to one characteristic of the invention, in non-storing mode a node which receives a multicast packet from a so-called child node, i.e. leading towards source 2, transfers this packet to its so-called parent node, i.e. a node leading to root node 4.

If the source cannot send its packets in multicast mode natively/directly, it sends its multicast packets in a unicast tunnel either to its nearby RPL node, or directly to root node 4. This is so, for example, when the source is located in a network which does not support multicast mode.

Thus, when the intermediate RPL node nearby source 2 receives a tunnelled packet from this source, it checks whether the destination address of the tunnel belongs to it. If so, the intermediate node opens the received packet by deleting the external IP header, and sends the opened packet in an unchanged state from its output interface to the next intermediate node in the direction of root node 4. Each intermediate node receiving a multicast packet from a child node (a node leading towards the source) thus transfers this packet to its parent node (a node leading towards root node 4).

If conversely the destination address of the packet does not belong to the intermediate RPL node nearby source 2 then this is normally the address of root node 4. In this case the intermediate RPL node sends the packet in an unchanged state from its output interface to the next intermediate RPL node in the direction of root node 4. This phase of transfer towards root node 4 may be accomplished according to the default unicast routing strategy of the RPL network (each node generally sends the packet to a node discovered in advance by means of an advertisement message (such as the DIO message (DODAG Information Object) of the RPL protocol).

On receipt of the packet, root node 4 checks whether the packet has a multicast destination address or a destination address which belongs to root node 4. Consequently, two cases must be distinguished: the first case in which the packets have a multicast destination address, and the second case, in which the packets have a unicast destination address which belongs to root node 4.

In the case of a multicast address, root node 4 checks whether this address is recorded in its routing table (for example, whether there is at least one entry giving this multicast address). If the multicast address exists root node 4 then proceeds to construct a set of routing headers. There will then thus be one routing header for each host. For each host of a given multicast group root node 4 generates a copy of the received packet and adds to it the routing header corresponding to the said host.

The routing header for a host host_i belonging to a multicast group mcast_j is constructed from the entry of the routing table corresponding to the combination (host_i@, mcast_j@). The header contains the IP address of the host and the IP address of each node on the host's path.

When the header has been constructed, it is added to a copy of the packet received by root node 4. The resulting packet is then tunnelled to the first node on the path towards the host. A new IP header is inserted in the resulting packet to give as the source address that of root node 4, and as the destination address that of the next node. This process, in root node 4, of construction of the routing header from the routing table, of generation of a copy of the received packet, of addition of the routing header to the copy of the received packet, and of tunnelling in unicast mode of the resulting packet to the first node on the host's path, is repeated for each host in the multicast group. All the entries of the routing table in which the multicast address of the packet is mentioned will consequently be used.

For example, according to table 1 above, a multicast packet addressed to group @_MC2, received by root node 4 will have the following form:

| | | |
|---|---|---|
| @ source: source_@ | @ dest: @_MC2 | Data (e.g. 1234567) |

For this same packet, root node 4 will generate two copies of the packets to be transmitted. Each copy will be associated with a different routing header; one corresponding to host H3, the other corresponding to host H4. Each resulting packet will then be tunnelled to node N5 using an external IP header the source address of which is that of root node 4, and the destination address of which is that of N5. The two final packets sent to H3 and H4 will thus have the following format:

External IP header Routing header Internal IP header

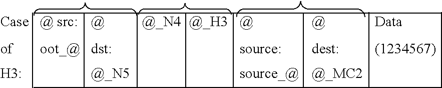

External IP header Routing header Internal IP header

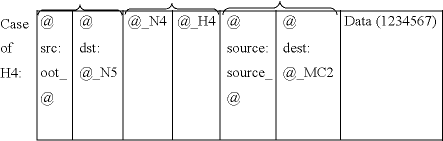

When the node given in the destination of the external IP header receives the packet, processing of the packet received in this node is identical to the processing of the packet with an IPv6 routing header in RPL. In particular, the node will switch the value given in the destination address of the external IP header (the value being the address of the current node) with the address of the next node given in the routing header (the position of the next node in the routing header is calculated according to the operation given for the IPv6 routing headers in the RPL protocol according to which the position is equal to the number of addresses in the routing header, minus the number of remaining segments; both of which are known from specific fields of the IPv6 routing header in RPL). The packet is then sent to the next node. The process (reception, address switching, transfer) is thus repeated for each node given in the routing header (except for the host).

FIG. 5 illustrates the steps of transfer of the packets from root node 4 to host H2.

In step 50 root node 4 sends the multicast packets to the first intermediate node on the path to the host. This intermediate node transfers the said packets to the next intermediate node (step 52), which transfers them to host node H2 (step 54).

For example, as illustrated in FIG. 6, when a packet is transferred from root node 4 to host H3, node N5 will switch the destination address of the external IP header (@_N5) with the address of the next node (@_N4) and will transfer the resulting packet to node N4. After this, node N4 will in its turn switch the destination address of the external IP header (@_N4) with the address of the next node (@_H3) and will transfer the resulting packet to host H3.

FIG. 7 is a flow chart illustrating how a data packet received by root node 4 is processed.

In step 70 root node 4 receives the data packet, and checks, in step 71, whether the destination address (@_dest) is either that of root node 4 or is of the multicast type.

If the destination address (@_dest) is neither that of root node 4 nor a multicast address the data packet is then routed according to the basic unicast mode of the RPL protocol (step 71a).

If so, root node 4 checks, in step 72, whether the address (@_dest) is of the multicast type.

If so, in step 73 root node 4 examines the routing table for the entry (*, @_dest), and checks, in step 74, whether this address (@_dest) is present in the routing table.

If the routing table does not contain the said address processing of the packet is terminated. If however root node 4 has a connection to an external network (typically by means of an interface network other than the one used to connect to the LLN network) it can transmit the multicast packet to this external network.

If the routing table contains the said address, in step 75 root node 4 recovers the address of host @_Hi of the entry of the routing table in which destination address @_dest has been found, and adds, to the routing header, all the nodes on the path of the stream which is to be sent to address @_Hi, except for the first node on this path.

In step 76, root node 4 generates a tunnel to transmit the resulting packet towards the first node located on the path of the stream which is to be sent to address @_Hi.

The process continues from step 73 for the next data packet.

If, conversely, the address (@_dest) is not of the mcast type, root node 4 checks, in step 77, whether the received packet is tunnelled.

If not, processing of the packet is terminated.

If it is, root node 4 opens the packet in step 78 and checks, in step 79, whether the destination address of the internal packet (@_dest) is of the multicast type.

If not, processing of the packet is terminated.

If it is, processing of the packet continues from step 73.

If the destination address of the packet received by root node 4 is a unicast address but does not belong to root node 4 the received packet is then routed according to the basic unicast mode of the RPL protocol.

It should be noted that if root node 4 has a connection to an external network (typically by means of an interface network other than the one used to connect to the LLN network) it can transmit the multicast packet towards this external network.

When a host receiver receives a tunnelled multicast packet with a routing header from root node 4 it removes the external IP header corresponding to the tunnel and also the routing header in order to recover the data.

A request to leave a multicast group may be transmitted either via messages using the MLD protocol (Multicast Listener Discovery) of IPv6, or messages with a protocol specific to LLN networks, such as, for example, DAO messages of the RPL protocol (RPL DAO containing a “Transit Information” option with a zero lifetime). These two cases must thus be distinguished: either transmission of an MLD request (MLD Report), or transmission of a request specific to the LLN (e.g. RPL DAO).

An MLD request will be transmitted by a non-RPL node in the sense of the RPL protocol which, according to the MLD standard, is sent in link-local multicast mode. In this case the host's message will be intercepted by an RPL router node. As soon as this RPL router receives the said MLD request it transforms it into a DAO message which will be sent to root node 4. This DAO message will include two “target” options. The first option will contain the unicast address of the host. The second “target” option will contain the multicast address of the group which the host wishes to leave. This DAO message will also contain two “Transit Information” options (one for each “target” option); one of them containing a zero “lifetime” field. The format of the DAO message for a given non-RPL host, namely host H2, for example (H2 is considered in this case as a non-RPL node), is thus described below:

DAO header

| @_H2 | @N_2 | @_MC3 | 0x00000000, @N_2 |
|---|---|---|---|
| Target opt1 | Transit opt1 | Target opt2 | Transit opt2 |

Furthermore, in the case of a host supporting messages specific to LLN networks such as an RPL network, the invention proposes that the said host (the RPL host) sends a DAO message instead of an MLD report message. The DAO message, in this case, has a format identical to the one described the case of a non-RPL host. This DAO message will be sent directly to the root.

However, the leave request may include (whether in the case of an RPL or non-RPL host) just the target option containing the multicast address with the “transit information” option, associated with a zero lifetime, if the unicast address of the host is mentioned as the source address of the IP header of the DAO message arriving at root node 4.

The existence of a multicast address in a target option, together with a zero “lifetime” field in the associated “Transit Information” option (whether in the case of an RPL on non-RPL host) will inform root node 4 that this is a request to leave a multicast group. In this case, if the association (host address, multicast address) exists in the routing table, the corresponding entry is then deleted from the routing table. If the entry does not exist, the host's request will be ignored by root node 4.

FIG. 8 is a flow chart illustrating how root node 4 processes requests to leave a multicast group sent by a host.

In step 80 root node 4 receives a DAO message from a host wishing to leave a multicast group, and checks, in step 81, whether the address of multicast group j (mcast_j) is present in a target option, and whether the unicast address of host Hi (@_Hi) is present in another target option.

If both these addresses are present in target options root node 4 proceeds to step 82.

If no multicast address is present in a target option processing of the message is terminated.

If a multicast address is present in a target option but no unicast address is present in a target option root node 4 then uses the source address of the DAO message as the said unicast address (e.g. =@_Hi) and proceeds to step 82.

In step 82 root node 4 checks whether the association (@_host_i, @_mcast_j) exists in the routing table.

If not, processing of the DAO message is terminated.

If so, root node 4 checks, in step 83, whether the “transit information” option is present in the DAO message.

If not, processing of the DAO message is terminated.

If so, root node 4 checks, in step 84, whether lifetime Tij of membership of host Hi in multicast group mcast_j is zero.

If not, root node 4 renews, in step 85, the membership of host (@_host_i) by an update of period Tij.

If so, root node 4 deletes, in step 86, entry (@_host_i, @_mcast_j) from the routing table.

In a first variant embodiment of the invention, the routing header describes the multicast tree going from root node 4 to all the multicast receivers. This enables the number of copies sent to the addressees of a multicast group to be decreased, and by this means enables the bandwidth to be optimised. This variant also defines a new type of IPv6 routing header for the RPL protocol.

FIG. 9 illustrates schematically an example in which source 2 sends the multicast packet with address @_MC1 to root node 4. Root node 4 then constructs the routing header and sends a single packet towards destinations @_H1, @_H2 and @_H3, which are members of group MC1.

In this variant, the procedures for joining and leaving the multicast group are identical to those described above with reference to FIGS. 2, 3 and 8.

As for the data transfer phase, it is accomplished as follows:

When root node 4 receives a packet from a multicast source 2 it checks whether the packet has a multicast destination address or a destination address which belongs to root node 4. Two cases must then be distinguished, depending on whether the destination address is a multicast or unicast address.

### Data Transfer in the Case of a Multicast Destination Address

### Operations in Root Node 4

If the packet has a multicast destination address root node 4 checks whether this address is recorded in its routing table (for example, whether there is at least one entry giving this multicast address). If the multicast address does not exist processing is terminated. If however root node 4 has a connection to an external network (typically by means of an interface network other than the one used to connect to the LLN network) it can transmit the multicast packet to this external network. If the multicast address exists root node 4 then proceeds to construct a single routing header for each of its sub-trees.

In this variant of the invention a sub-tree of a root node represents the tree going from a child (or from a next node at one stage from root node 4) to the hosts served by this sub-tree. In the example of FIG. 9, root node 4 thus has a single sub-tree going from node N1 to hosts H1, H2 and H3.

The routing header described in this variant of the invention is of a new type since its format is different from that of IPv6 routing header for RPL [J. Hui et al. “An IPv6 Routing Header for Source Routes with RPL”, Internet draft, (Work in Progress), 2011]). This routing header will contain the IP addresses of all the nodes (called multicast routers) of the sub-tree, except for the top node of the sub-tree, together with the addresses of all the hosts of this sub-tree.

Root node 4 will generate as many copies of the received multicast packet as there are sub-trees (or generated headers). Each of these copies of the multicast packet will be added to a routing header associated with a separate sub-tree of root node 4. The packet resulting from each association (copy of packet and routing header) will then be tunnelled to a child node (child of root node 4) associated with the header. A new IP header is inserted in the resulting packet to give as the source address that of root node 4, and as the destination address that of the next node.

FIG. 10 illustrates the generic format of a multicast packet at the output of root node 4 and which is to be sent to hosts H1, H2 and H3.

Since the number of child nodes of the current node (next nodes at one stage from the current node) may be greater than or equal to 1, and for the sake of clarity, each set of nodes in the same position in the routing header (e.g. nodes @_N2 and @_N3 of FIG. 9) will be considered as a logical node.

Secondly, according to the present variant of the invention, the number of child nodes of a current node is deduced from a specific field of the routing header which will be associated with each logical node of the routing header.

As illustrated by FIG. 10, as an example, the number of child nodes of the current node is given just before the list of these next nodes.

Furthermore, in order to explain clearly the operations in the different nodes of a sub-tree of root node 4, the operations in the child node of root node 4 will be noted “level 1 operations”, and the operations in the intermediate nodes of the sub-tree of root node 4 will be noted “level 2 operations”. Finally, operations in the hosts will be noted “level 3 operations”.

### Operations in a Multicast Router Node (Not Root Node 4)

When a multicast router node receives a multicast packet from a parent node (where the parent node is root node 4 or another multicast router node) the processing of the received packet in this node depends on the number of child nodes of this current node (next nodes at one stage from the current node) which are included in the routing header.

In the present variant, the position of the next child nodes of a current node is calculated considering all these nodes as a logical node in the routing header. This will allow application of the position calculation method described in [J. Hui et al. “An IPv6 Routing Header for Source Routes with RPL”, Internet draft, (Work in Progress), 2011]). In other words, the position sought is equal to the number of logical nodes in the routing header, minus the number of remaining segments; where both may be known by using the same fields as those of the IPv6 routing header in the case of RPL

If the number of child nodes of the current node is equal to 1, the processing of the packet received by the current node is identical to the basic approach described above, comprising reception of the packets, address-switching and transfer.

If the number of child nodes of the current node is greater than 1, the current node generates as many copies of the internal packet (an internal packet is delimited by the internal IP header and the data, as illustrated by FIG. 10) as there are children. The current node then generates, for each of these child nodes, a new header which will include all the nodes of the sub-tree from the child node of the current node (without including the child node) as far as the hosts associated with this sub-tree.

For each generated routing header the current node replaces the value given in the destination address of the external IP header of the received packet (where the value is the address of the current node) by the address of its child node. The current node then puts the replaced address (the address of the current node) in the first position of the generated header, and finally copies into it, from the received header, all the nodes from the first node of this header (first node visited by the received packet) to the parent node of the current node.

The current node will then associate the new external IP header with the generated routing header, and also with a copy of the internal packet, and sends the resulting packet to its child.

This procedure (association and transmission) is repeated for each child node of the current node. The process (reception of a multicast packet by a multicast router node, processing of the packet according to the number of child nodes of this router) is repeated in this manner for each node included in the routing header (except for the host).

FIG. 11 illustrates schematically the generic format of a multicast packet at the output of node N1 (child node of root node 4) and which is to be sent to its child nodes N2 and N3 of FIG. 9.

FIG. 12 illustrates schematically the generic format of a multicast packet at the output respectively of nodes N2 and N3 and which is to be sent to nodes N4, N5 and N6 of FIG. 9.

As illustrated by this FIG. 12, the number of next nodes at one stage from each of these nodes N4, N5, N6 is equal to 1. The processing of the packet received by each of these nodes is therefore identical to the basic approach comprising reception of the packet, address-switching, and transfer of the said packets.

### Data Transfer in the Case of a Unicast Destination Address (Address of the Root Node)

If the destination address of the packet received by root node 4 is a unicast address, this node checks whether this address belongs to it. If it does not, it transfers the packet to its given destination, using the traditional unicast routing of the RPL protocol. If the unicast address belongs to root node 4 it is in this case a multicast-in-unicast tunnel. Root node 4 then opens the packet to recover the internal multicast packet, which will be processed in the same way as in the case of the transfer of the data packets with a multicast destination address.

It should be noted that this variant does not require major constraints in terms of the routers of the multicast tree, namely: an overall view of the network (and therefore of the major routing tables) and a calculation of the routes in terms of the intermediate nodes. In the proposed variant the end-to-end routes are given in the routing header.

According to a second variant embodiment of the invention, to reduce the number of copies sent to the addressees of a multicast group, and to optimise bandwidth, the support of the multicast routing in the RPL protocol in non-storing mode is modified so as to propose that root node 4 generates a copy of the multicast packet and a copy of the routing header for each last multicast RPL router on the receiver's path, rather than generating such copies for each receiver, as is proposed by the basic approach.

This approach is an optimisation of the approached described in the first variant.

In this approach the routing header generated by root node 4 will not include the receiver's address, since there is no longer any requirement for such an address in the last multicast RPL router towards this receiver.

This last receiver will, indeed, transmit the multicast packets natively towards the receiver (i.e. without tunnelling. At protocol stack level 2 this is reflected by a broadcast frame). To accomplish this, each time an RPL router, noted Nx, receives a tunnelled multicast packet with a routing header it checks whether it is the last node of the routing header. If so, it opens the received packet (deletes the external header), deletes the routing header, and then sends the internal packet natively to the receiver(s).

FIG. 13 shows again the example of table 1, in which the multicast packet of address @_MC3 is sent to host @_H2. If Nx is not the last node of the routing header the processing of the packet in Nx will follow the operations given in the basic approach (reception, address-switching, transfer), or of variant 1 (reception of a multicast packet by a multicast router node, processing of the packet according to the number of child nodes of this router).

This approach is simple in the sense that it requires no modification of the routing header format if it is applied to the basic approach or to variant 1. In addition, it requires only simple operations (described above) to be defined/implemented in root node 4 and the RPL routers.

In a third variant embodiment of the invention, the routing header in the data transfer procedure contains the multicast address of the group as the final destination. The internal header of the basic approach (header with multicast destination address) is thus no longer required. However, this variant requires that the specification of the routing header is modified in the RPL context, which prohibits use of a multicast address in the routing header.

In a fourth variant embodiment of the invention, the receiver sends a multicast join request of the tunnelled MLD Report type to root node 4. This is useful if the (non-root) RPL routers do not have MLD router functionality.

In this precise case, root node 4 is assumed to be an MLD router (MLD Querier). The remainder of the process (storage of memberships, updating of the multicast routing table, and construction of the routing headers) is identical to that of the basic solution.

In a fifth variant embodiment of the invention, root node 4 deletes the internal IP header of the multicast packet (the header the destination of which is the group's multicast address) before sending it with the appropriate routing header to the receiver (basic approach) or receivers (variant 1). This variant assumes that the receiver has associated (before its join request) its unicast address given in the routing header with the multicast address of the group which it has joined. The unicast address of the host may be, for example, a virtual address. When a packet is received with a routing header, the receiver will thus extract its unicast address from the routing header and will recover internally the associated multicast address.

1. A method for routing in non-storing mode packets of a stream exchanged between a source (2) and at least one receiver Hi (i=1, 2, 3, . . . ) identified by a unicast address, and having previously joined at least one multicast group MCj (j=1, 2, 3, . . . ) in a network of the LLN type including a set of non-storing nodes Ni (i=1, 2, 3, . . . ) and a root node, capable of recording the routing data, a method characterised in that it includes the following steps:
sending through receiver Hi to the root node (4) a request to join a multicast group MCj (j=1, 2, 3, . . . ) containing the unicast address of receiver Hi and the multicast address of the said multicast group,
associating (38), in a multicast routing table managed by the root node (4), multicast address MCj with the unicast address of receiver Hi having joined multicast group MCj, and also with the list of intermediate nodes on the path between the root node (4) and said receiver Hi;
transmitting a packet of a multicast stream from the source (2) to the root node (4);
and on receipt of the packet of the multicast stream, the root node (4) generates a copy of the said packet, adds to the generated copy a routing header containing a list of intermediate nodes on the path between the root node (4) and said receiver Hi, and sends the said copy of the multicast packet to receiver Hi via the said list of intermediate nodes.

2. A method according to claim 1 in which receiver Hi sends the root node (4) the join request via a DAO (Destination Advertisement Object) message of the RPL (Routing Protocol for Low power and Lossy Networks) protocol or via an MLD (Multicast Listener Discovery) report message

3. A method according to claim 1 in which receiver Hi sends the said join request with a link-local multicast or, in unicast mode, sends it directly to the root node (4), and on receipt of the request the root node (4) records the receiver in the multicast routing table.

4. A method according to claim 1 in which the said multicast routing table also includes a list of intermediate nodes intended to transfer the packets from the root node (4) to receiver Hi.

5. A method according to claim 1 in which the unicast address of receiver Hi is either its real unicast address, or a virtual address internal to receiver Hi.

6. A method according to claim 4 in which, when an intermediate node Ni receives a multicast packet, if the destination address of the tunnel belongs to said node Ni, the latter deletes the external IP header of the received packet and sends the multicast packet in an unchanged state from its output interface to the next intermediate node in the direction of the root node (4).

7. A method according to claim 4 in which, when an intermediate node Ni receives a multicast packet, if the destination address of the packet does not belong to said node Ni, the latter sends the packet in an unchanged state from its output interface to the next intermediate node in the direction of the root node (4).

8. A method according to claim 1 in which, when the root node (4) receives a packet, it checks whether the packet has a multicast destination address or a destination address which belongs to it, and,
if the packet has a multicast address the root node (4) checks whether this address is recorded in its routing table,
if the multicast address exists in the routing table the root node (4) constructs a set of routing headers, and sends the multicast packet to the addressee nodes using the said routing headers.

9. A method according to claim 1 in which, if the destination address of the packet received by the root node (4) is a unicast address, the root node (4) checks whether this address belongs to it and,
if so the root node (4) opens the received packet, and,
if the packet has a multicast address the root node (4) checks whether this address is recorded in the routing table,
if the multicast address exists in the routing table the root node (4) constructs a set of routing headers, and sends the multicast packet to the addressee nodes using the said routing headers,
if not, the received packet is then routed according to the unicast mode of the RPL protocol.

10. A computer program recorded on a recording medium, containing instructions to implement, when it is executed by computer, the steps of the method according to claim 1.
